(19) United States
(12) Patent Application Publication
(10) Pub. No.: US 2018/0150992 A1
(43) Pub. Date: May 31, 2018

(54) MEDICAL IMAGE MODELING SYSTEM AND MEDICAL IMAGE MODELING METHOD

(71) Applicant: Metal Industries Research & Development Centre, Kaohsiung (TW)

(72) Inventors: Kai-Szu Lo, Tainan City (TW); Sheng-Hong Yang, Kaohsiung City (TW); Bo-Wei Pan, Kaohsiung City (TW); Tsung-Chih Yu, Tainan City (TW)

(73) Assignee: Metal Industries Research & Development Centre, Kaohsiung (TW)

(21) Appl. No.: 15/485,238

(22) Filed: Apr. 12, 2017

(30) Foreign Application Priority Data
Nov. 30, 2016 (TW) 105139358

(51) Int. Cl. G06T 15/10

(52) U.S. Cl. CPC G06T 15/10; G06T 2210/41

(57) ABSTRACT

A medical image modeling system including a processing device, a display device, and an input device is provided. The processing device is configured to execute an image processing module to generate three-dimensional bone model data based on medical image data of a biological bone tissue. The display device is configured to simultaneously display a medical image and a three-dimensional bone model in the same operation interface according to the medical image data and the three-dimensional bone model data. The input device is configured to receive a parameter instruction, so that the processing device edits the three-dimensional bone model according to the parameter instruction by the image processing module. A medical image modeling method is also provided.

### CROSS-REFERENCE TO RELATED APPLICATION

This application claims the priority benefit of Taiwan application serial no. 105139358, filed on Nov. 30, 2016. The entirety of the above-mentioned patent application is hereby incorporated by reference herein and made a part of this specification.

### BACKGROUND OF THE INVENTION

### Field of the Invention

The invention relates to an image modeling technique and more particularly relates to a medical image modeling system and a medical image modeling method.

### Description of Related Art

In the treatment for bone repair, it is common to use an artificial bone repair model to restore bone defects in bone repair surgery. The conventional artificial bone repair model is made by using medical image software to read a medical image of the bone tissue and then using conversion software to convert the medical image into a stereoscopic bone image. For this reason, production of the conventional artificial bone repair model involves a complex process of image file format conversion, which is rather inconvenient for producing the repair model. Therefore, how to provide an image processing system for simultaneously processing and analyzing the medical image and the stereoscopic bone model and directly editing/drawing the stereoscopic bone model or simulating the repair model of the bone tissue in the image processing system remains an important issue.

### SUMMARY OF THE INVENTION

The invention provides a medical image modeling system and an operation method thereof for executing an image processing module, so as to build a stereoscopic bone model according to a medical image of a biological bone structure and simultaneously displaying the medical image and the stereoscopic bone model in the same operation interface.

The medical image modeling system of the invention includes a processing device, a display device, and an input device. The processing device is configured to execute an image processing module to generate stereoscopic bone model data based on medical image data of a biological bone tissue. The display device is coupled to the processing device. The display device is configured to simultaneously display a medical image and a stereoscopic bone model in the same operation interface according to the medical image data and the stereoscopic bone model data. The input device is coupled to the processing device. The input device is configured to receive a parameter instruction, so that the processing device edits the stereoscopic bone model according to the parameter instruction by the image processing module.

In an embodiment of the invention, the medical image data conforms to Digital Imaging Communications in Medicine (DICOM) and the stereoscopic bone model data conforms to a stereo lithography (STL) format.

In an embodiment of the invention, the medical image modeling system further includes a storage device. The storage device is coupled to the processing device. The storage device is configured to store the image processing module and a mechanics analysis module. The processing device analyzes the stereoscopic bone model by executing the mechanics analysis module to obtain modeling reference data.

In an embodiment of the invention, the processing device integrates the modeling reference data into the stereoscopic bone model, so that the stereoscopic bone model displayed by the display device includes the biological bone tissue and a repair model.

In an embodiment of the invention, the medical image modeling system is further coupled to an external output device. The output device is configured to produce a physical model object according to the repair model.

In an embodiment of the invention, the processing device further analyzes the medical image data to obtain at least one of a reference point, a reference angle, and a reference line of the biological bone tissue, so that the display device marks at least one of the reference point, the reference angle, and the reference line on the biological bone tissue displayed in the stereoscopic bone model.

In an embodiment of the invention, the medical image modeling method is adapted for a medical image modeling system. The medical image modeling system includes a processing device, a display device, and an input device. The medical image modeling method includes the following steps. An image processing module is executed to generate stereoscopic bone model data based on medical image data of a biological bone tissue. A medical image and a stereoscopic bone model are simultaneously displayed in a same operation interface according to the medical image data and the stereoscopic bone model data by the display device. A parameter instruction is received by the input device to edit the stereoscopic bone model according to the parameter instruction by the image processing module.

In an embodiment of the invention, the medical image data conforms to Digital Imaging Communications in Medicine (DICOM) and the stereoscopic bone model data conforms to a stereo lithography (STL) format.

In an embodiment of the invention, the medical image modeling system further includes a storage device configured to store the image processing module and a mechanics analysis module. The medical image modeling method further includes the following steps. The mechanics analysis module is executed to analyze the stereoscopic bone model data to obtain modeling reference data.

In an embodiment of the invention, the medical image modeling method further includes the following steps. The modeling reference data and the stereoscopic bone model data are integrated, so that the stereoscopic bone model displayed by the display device includes the biological bone tissue and a repair model.

In an embodiment of the invention, the medical image modeling method further includes the following steps. A physical model object is produced according to the repair model by an output device.

In an embodiment of the invention, the medical image modeling method further includes the following steps. The medical image data is further analyzed by the image processing module to obtain at least one of a reference point, a reference angle, and a reference line of the biological bone tissue. At least one of the reference point, the reference angle, and the reference line is further marked on the biological bone tissue displayed in the stereoscopic bone model.

Based on the above, the medical image modeling system and the method thereof in the embodiments of the invention convert the medical image data of the biological bone tissue into the stereoscopic bone model by executing the image processing module and simultaneously display the medical image and the stereoscopic bone model in the same operation interface through the display device. The image processing module in the embodiments of the invention is further configured to edit and draw the stereoscopic bone model according to the parameter instruction inputted by the input device.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic diagram of a medical image modeling system according to an embodiment of the invention.

FIG. 2 is a schematic diagram of an operation interface according to an embodiment of the invention.

FIG. 3 is a schematic diagram of editing a stereoscopic bone model according to an embodiment of the invention.

FIG. 4 is a schematic diagram of analyzing a medical image according to an embodiment of the invention.

FIG. 5 is a flowchart showing a medical image modeling method according to an embodiment of the invention.

### DESCRIPTION OF THE EMBODIMENTS

The term “couple” used throughout this specification (including the claims) may refer to any direct or indirect connection means. For example, if it is described that the first device is coupled to the second device, it should be understood that the first device may be directly connected to the second device or indirectly connected to the second device through other devices, wires, or certain connection means. Moreover, elements/components/steps with the same reference numerals represent the same or similar parts in the figures and embodiments where appropriate. Descriptions of the elements/components/steps with the same reference numerals or terms in different embodiments may be reference for one another.

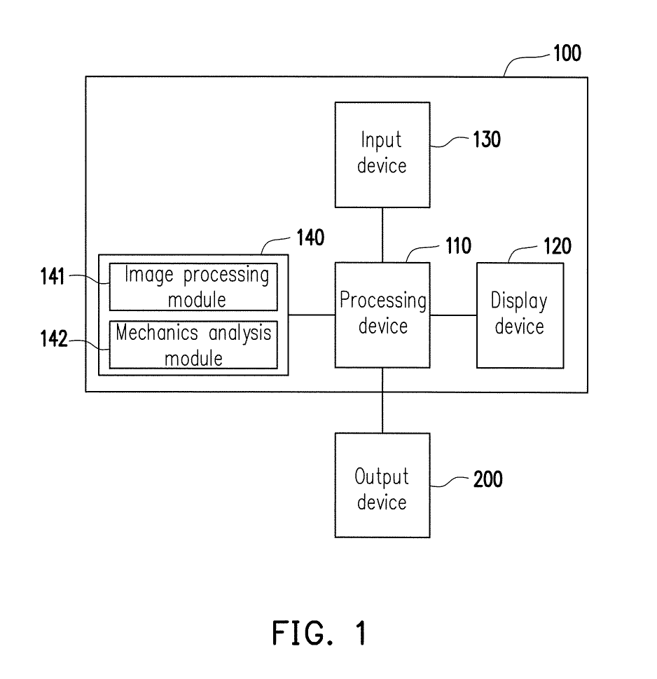

FIG. 1 is a schematic diagram of a medical image modeling system according to an embodiment of the invention. Referring to FIG. 1, a medical image modeling system 100 includes a processing device 110, a display device 120, an input device 130, and a storage device 140. The processing device 110 is coupled to the display device 120, the input device 130, and the storage device 140. The storage device 140 is configured to store an image processing module 141 and a mechanics analysis module 142. In this embodiment, the medical image modeling system 100 receives medical image data inputted from outside or stores the medical image data in the storage device 140 in advance. It should be noted that the medical image data described in this embodiment refers to a tomography file conforming to Digital Imaging Communications in Medicine (DICOM), such as computed tomography (CT), magnetic resonance imaging (MRI), and so on. Besides, the medical image data of this embodiment belongs to image data of a biological bone tissue.

In this embodiment, the processing device 110 executes the image processing module 141 to compute medical image data of the biological bone tissue, so as to generate stereoscopic bone model data based on the medical image data of the biological bone tissue, wherein the stereoscopic bone model data conforms to a stereo lithography (STL) format. In addition, the image processing module 141 may convert a three-dimensional image (volumn) formed by stacking multiple layers of two-dimensional medical images (pixle) into three-dimensional mesh data, so as to generate a stereoscopic bone model of a polygonal mesh.

In this embodiment, the processing device 110 provides the medical image data and the stereoscopic bone model data to the display device 120 for the display device 120 to display a medical image and the stereoscopic bone model. The medical image modeling system 100 receives a parameter instruction provided by a user via the input device 130, so that the processing device 110 edits the stereoscopic bone model according to the parameter instruction provided by the user by the image processing module 141.

It should be noted that the image processing module 141 and the mechanics analysis module 142 of this embodiment are implemented in the form of software and are stored in the storage device 140. The image processing module 141 of this embodiment is configured to directly convert the medical image data into the stereoscopic bone model data under a software architecture and is capable of drawing and editing the stereoscopic bone model. Nevertheless, the invention is not limited thereto. In an embodiment, the image processing module 141 may be a plurality of software architectures including a plurality of submodules. For example, the image processing module 141 may include a format conversion submodule and a model editing submodule. The processing device 110 may execute the format conversion submodule to convert the medical image data into the stereoscopic bone model data and execute the model editing submodule to edit the stereoscopic bone model data. In addition, the mechanics analysis module 142 of this embodiment is configured to perform a mechanics analysis on the medical image data in coordination with an analysis program or algorithm executed by the image processing module 141. The image processing module 141 and the mechanics analysis module 142 of this embodiment can be understood sufficiently based on the teaching, suggestion, and illustration relating to this field. Thus, details thereof are not repeated hereinafter.

In this embodiment, the processing device 110 may include a single-core or multi-core central processing unit (CPU), a programmable microprocessor for general or special use, a digital signal processor (DSP), a programmable controller, an application specific integrated circuit (ASIC), a programmable logic device (PLD), other similar devices, or a combination of these devices for executing an arithmetic instruction or algorithm related to the image processing module of the embodiments of the invention. Moreover, the storage device 140 may be a random access memory (RAM), a read-only memory (ROM), or a flash memory, which is at least configured to store the image processing module 141 and the mechanics analysis module 142 described in the embodiments of the invention.

In this embodiment, the input device 130 is a physical keyboard, a mouse, a button, a touchpad, or a similar physical component, for example. Alternatively, the input device 130 may be an operation interface displayed by executing a software program, for example. The display device 120 is a display having a touch function, for example. The display device 120 displays image information of the operation interface and allows the user to input the parameter instruction by touching the display device 120. Alternatively, the user may input the parameter instruction through an additional physical keyboard. Nevertheless, the invention is not limited to the above.

Specifically, the image processing module 141 of this embodiment extracts a bone surface from the medical image of the biological bone tissue to form the stereoscopic bone model. First, the processing device 110 of this embodiment executes the image processing module 141 to perform image segmentation on multiple slicing images in the medical image data obtained through tomography, and retains image pixels of the bone tissue portion by removing image pixels of other tissues. An image processing principle of the image segmentation is to determine whether the pixels in the image belong to the bone tissue based on Hounsfield unit (HU) values. Then, the image processing module 141 may include a volume rendering algorithm. The processing device 110 of this embodiment performs three-dimensional reconstruction on the image pixels of the aforementioned bone tissue portion by executing the volume rendering algorithm. Then, the image processing module 141 may further include a conversion algorithm of a marching cubes algorithm. The processing device 110 of this embodiment converts the medical image that has been three-dimensionally reconstructed into the stereoscopic bone model that conforms to the stereo lithography (STL) format by executing the marching cubes algorithm. Finally, the medical image modeling system 100 simultaneously displays the medical image and the stereoscopic bone model in the same operation interface (or the same display screen) through the display device 120. In other words, the user is able to see the medical image and the stereoscopic bone model at the same time in the display screen of the same operation interface displayed by the display device 120 to draw and edit the stereoscopic bone model.

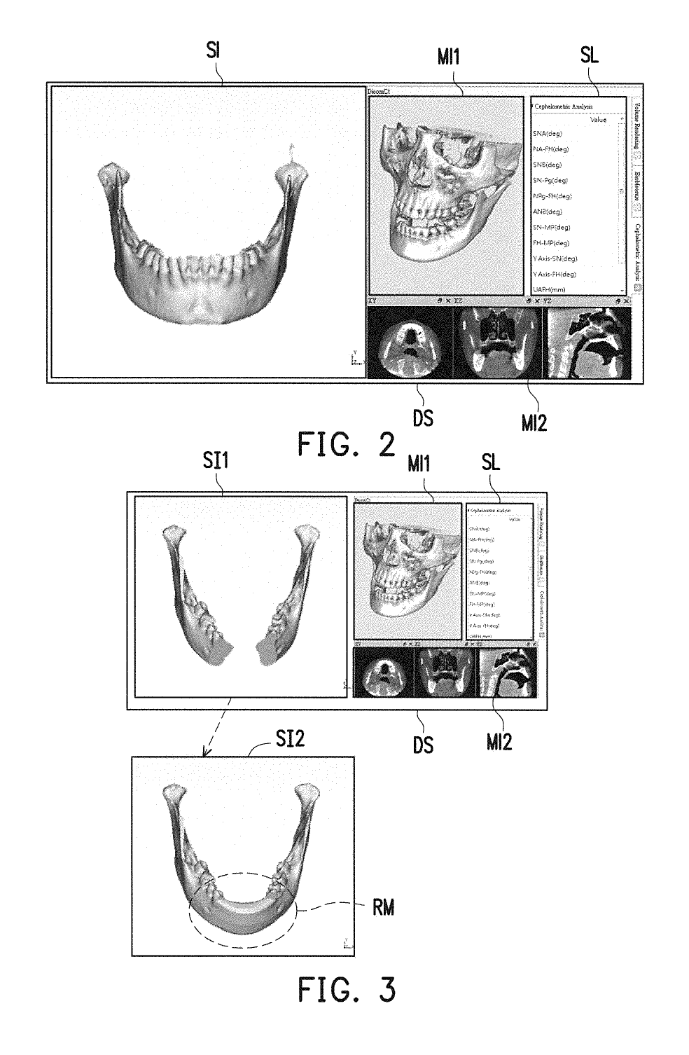

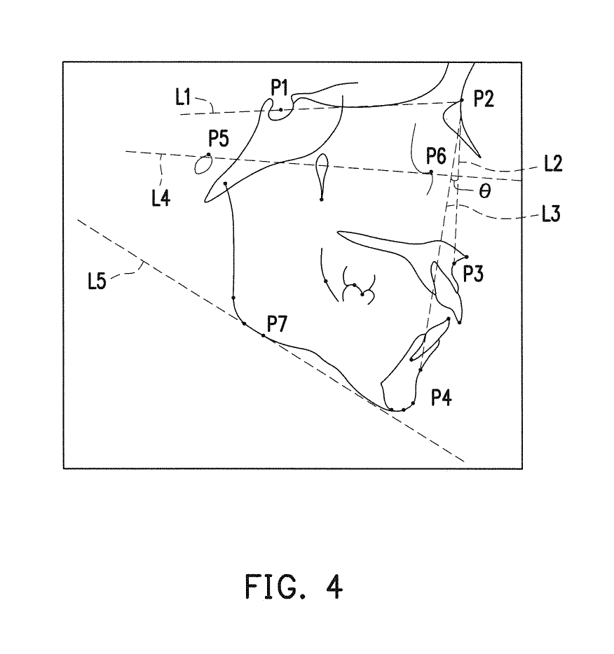

For example, FIG. 2 is a schematic diagram of the operation interface according to an embodiment of the invention. Referring to FIG. 1 and FIG. 2, the stereoscopic bone model of this embodiment is suitable for an image editing process. Therefore, when the medical image modeling system 100 displays medical images MI1 and MI2 and a stereoscopic bone model SI simultaneously in a display screen DS of the same operation interface by executing the image processing module 141, the user is allowed to input a parameter instruction related to modification or editing of the stereoscopic bone model SI through the input device 130 to draw and edit the stereoscopic bone model SI. For example, the stereoscopic image may be a mesh image in the stereo lithography (STL) format. Therefore, the processing device 110 may execute a stereoscopic drawing function of computer aided drawing (CAD), such as SolidWorks, for drawing and editing the stereoscopic bone model SI. The operation interface displayed by the display screen DS may further include an analysis list SL. The analysis list SL may include a plurality of preset bone drawing analysis functions for the user to select. The preset bone drawing analysis functions may include a reference point, a reference line, or a reference angle of a cephalometric analysis, for example. When the user selects the drawing analysis function, the image processing module 141 analyzes the stereoscopic bone model SI to obtain relevant values or display relevant marking information in the stereoscopic bone model SI, as will be further described in the embodiment of FIG. 4.

Further, for example, FIG. 3 is a schematic diagram of editing the stereoscopic bone model according to an embodiment of the invention. Referring to FIG. 1 and FIG. 3, the user may remove part of the bone tissue from a stereoscopic bone model SI1 for editing, so as to build a repair model. In this embodiment, when the medical image modeling system 100 displays the medical images MI1 and MI2 and the stereoscopic bone model SI1 simultaneously in the display screen DS of the same operation interface, besides drawing and editing the stereoscopic bone model SI1 according to the parameter instruction inputted by the user through the image processing module 141, the processing device 110 further performs a bone biomechanical analysis on the stereoscopic bone model SI1 based on the built-in mechanics analysis module 142 so as to obtain corresponding modeling reference data, such as data of bone density, bone hardness, and influence of stress. Moreover, the processing device 110 draws and edits the stereoscopic bone model SI1 based on the modeling reference data, so as to draw a repair model RM in a stereoscopic bone model SI2. In an embodiment, the processing device 110 may directly simulate the repair model RM as the modeling reference data. In this embodiment, the medical image MI1 is a stereogram of a skull and the medical image MI2 includes a plurality of tomographic profiles of the skull, for example. In other words, the user may refer to the medical images MI1 and MI2 while drawing and editing the stereoscopic bone model SI1, and the display depths and perspectives of the medical images MI1 and MI2 may be adjusted as required and are not limited to the disclosure of FIG. 3.

In this embodiment, the medical image modeling system 100 is further coupled to an output device 200. When the repair model RM of the stereoscopic bone model SI2 is completed, the medical image modeling system 100 produces a physical model object by the output device 200. In this embodiment, the output device 200 is an automatic modeling device or a 3D printer, for example. The processing device 110 outputs modeling data of the repair model RM to the output device 200, wherein the modeling data conforms to the stereo lithography (STL) format. Thereby, the output device 200 produces the physical model object according to the modeling data of the repair model RM.

FIG. 4 is a schematic diagram of analyzing a medical image according to an embodiment of the invention. Referring to FIG. 1 and FIG. 4, a lateral skull analysis is described hereinafter as an example. If the user wishes to model a certain bone of the lateral skull of a human skull, the processing device 110 of this embodiment further executes the image processing module 141 to analyze the medical image of the lateral skull so as to obtain a medical analysis image as shown in FIG. 4. In the medical image for lateral skull analysis, the processing device 110 analyzes the skull lateral bone to obtain reference points P1 to P7, reference lines L1 to L5, and a reference angle θ, as shown in FIG. 4. In this embodiment, the reference points P1 to P7 may be the sella, nasion, maxilla, nasal spine, or mandibular symphysis, for example. In this embodiment, the reference line L1 connects P1 and P2, for example. The reference lines L2 and L3 respectively connect P2 with P3 and P4, for example. L4 connects P5 and P6, for example. L5 is a boundary reference line of the mandible, for example. The reference angle θ is formed between the reference lines L2 and L3, for example.

In other words, the processing device 110 of this embodiment marks the reference points P1 to P7, the reference angle θ, and the reference lines L1 to L5 correspondingly on the stereoscopic bone model of each of the embodiments described above through the image processing module 141. Therefore, when the user edits or draws the stereoscopic bone model, the reference points P1 to P7, the reference angle θ, and the reference lines L1 to L5 may help the user complete the repair model. Nevertheless, the medical analysis image obtained through analysis of the medical image performed by the image processing module 141 is not limited to the disclosure of FIG. 4. In an embodiment, the reference points, the reference angle, and the reference lines in the medical analysis image may be determined according to the type of the biological bone tissue.

It should also be noted that the medical age modeling described in the embodiments of the invention is not necessarily for the skull image shown in FIG. 2 to FIG. 4. The medical image processing according to the embodiments of the invention is applicable to the image processing, analysis, and modeling of various biological bone images.

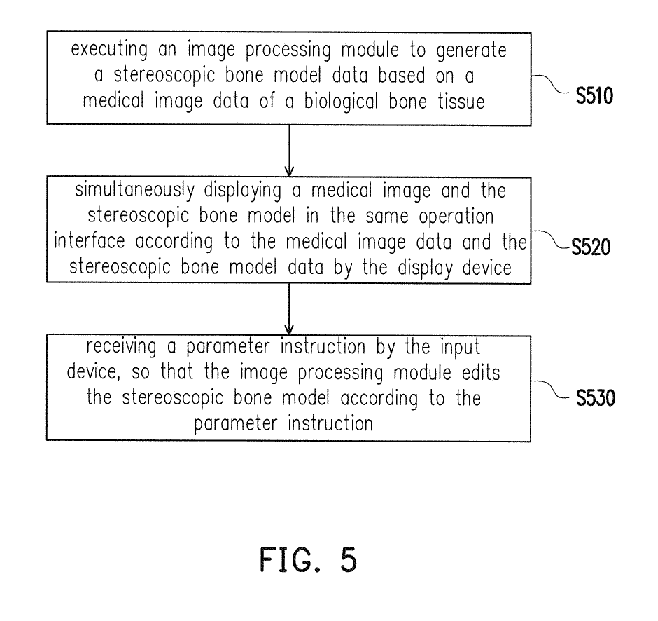

FIG. 5 is a flowchart showing a medical image modeling method according to an embodiment of the invention. Referring to FIG. 1 and FIG. 5, the medical image modeling method of this embodiment is at least applicable to the medical image modeling system 100 of FIG. 1. In this embodiment, the medical image modeling system 100 includes the processing device 110, the display device 120, the input device 130, and the storage device 140. The storage device 140 is configured to store the image processing module 141 and the mechanics analysis module 142. In this embodiment, the medical image modeling method includes the following steps. In Step S510, the medical image modeling system 100 uses the processing device 110 to execute the image processing module 141 to generate the stereoscopic bone model data based on the medical image data of the biological bone tissue. Then, in Step S520, the medical image modeling system 100 uses the display device 120 to simultaneously display the medical image and the stereoscopic bone model in the same operation interface according to the medical image data and the stereoscopic bone model data. At last, in Step S530, the medical image modeling system 100 uses the input device 130 to receive the parameter instruction, so that the image processing module 141 edits the stereoscopic bone model according to the parameter instruction.

Furthermore, other details of implementation of the medical image modeling method of this embodiment can be understood sufficiently from the teaching, suggestion, and illustration of the embodiments of FIG. 1 to FIG. 4 and thus are not repeated hereinafter.

To conclude, in the medical image modeling system and the method thereof described in the embodiments of the invention, the image processing module is executed to convert the medical image conforming to the Digital Imaging Communications in Medicine (DICOM) into the stereoscopic mesh image conforming to the stereo lithography (STL) format, and the stereoscopic image may be edited and drawn. In addition, the medical image modeling system described in the embodiments of the invention is capable of simultaneously displaying the medical image of the biological bone tissue and the stereoscopic bone model in the same operation interface through the display device. In other words, the user may refer to bone-related information in the medical image while editing and drawing the stereoscopic bone model. Furthermore, the medical image modeling system described in the embodiments of the invention further analyzes the medical image to obtain the reference point, reference angle, and reference line relating to the biological bone tissue and integrates the marking in the stereoscopic image.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

1. A medical image modeling system, comprising:
a processor, configured to execute an image processing module to generate three-dimensional bone model data based on medical image data of a biological bone tissue;
a display, coupled to the processor, and configured to simultaneously display a medical image and a three-dimensional bone model in a same operation interface according to the medical image data and the three-dimensional bone model data; and
an input device, coupled to the processor, and configured to receive a parameter instruction, so that the processor edits the three-dimensional bone model according to the parameter instruction by the image processing module,
wherein the processor executes a three-dimensional drawing function according to the parameter instruction to draw and edit a repair model, and adds the repair model to the three-dimensional bone model.

2. The medical image modeling system according to claim 1, wherein the medical image data conforms to Digital Imaging Communications in Medicine (DICOM), and the three-dimensional bone model data conforms to a stereo lithography (STL) format.

3. The medical image modeling system according to claim 1, further comprising:
a memory, coupled to the processor, and configured to store the image processing module and a mechanics analysis module,
wherein the processor analyzes the three-dimensional bone model by executing the mechanics analysis module to obtain modeling reference data.

4. The medical image modeling system according to claim 3, wherein the processor integrates the modeling reference data into the three-dimensional bone model, so that the three-dimensional bone model displayed by the display comprises the biological bone tissue and the repair model.

5. The medical image modeling system according to claim 4, wherein the medical image modeling system is further coupled to an printer, which is configured to produce a physical model object according to the repair model.

6. The medical image modeling system according to claim 1, wherein the processor further analyzes the medical image data by the image processing module to obtain at least one of a reference point, a reference angle, and a reference line of the biological bone tissue, so that the display marks at least one of the reference point, the reference angle, and the reference line on the biological bone tissue displayed in the stereoscopic bone model.

7. A medical image modeling method adapted for a medical image modeling system, which comprises a processor, a display, and an input device, the medical image modeling method comprising:
executing an image processing module to generate three-dimensional bone model data based on medical image data of a biological bone tissue;
simultaneously displaying a medical image and a three-dimensional bone model in a same operation interface according to the medical image data and the three-dimensional bone model data by the display; and
receiving a parameter instruction by the input device to edit the three-dimensional bone model according to the parameter instruction by the image processing module, wherein the processor executes a three-dimensional drawing function according to the parameter instruction to draw and edit a repair model, and adds the repair model to the three-dimensional bone model.

8. The medical image modeling method according to claim 7, wherein the medical image data conforms to Digital Imaging Communications in Medicine (DICOM) and the three-dimensional bone model data conforms to a stereo lithography (STL) format.

9. The medical image modeling method according to claim 7, wherein the medical image modeling system further comprises a memory configured to store the image processing module and a mechanics analysis module, wherein the medical image modeling method further comprises:
executing the mechanics analysis module to analyze the three-dimensional bone model data to obtain modeling reference data.

10. The medical image modeling method according to claim 9, further comprising:
integrating the modeling reference data and the three-dimensional bone model data, so that the three-dimensional bone model displayed by the display comprises the biological bone tissue and the repair model.

11. The medical image modeling method according to claim 10, further comprising:
producing a physical model object according to the repair model by printer.

12. The medical image modeling method according to claim 7, further comprising:
further analyzing the medical image data by the image processing module to obtain at least one of a reference point, a reference angle, and a reference line of the biological bone tissue; and
further marking at least one of the reference point, the reference angle, and the reference line on the biological bone tissue displayed in the stereoscopic bone model.
